(19) United States
(12) Patent Application Publication
(10) Pub. No.: US 2006/0013994 A1
(43) Pub. Date: Jan. 19, 2006

(54) Composite materials for siding, window and door surrounds and other cladding for buildings

(76) Inventors: Aubrey Burke, Booneville, MS (US); Ashley K. Green, Booneville, MS (US); Chris R. Gapen, Booneville, MS (US)

Correspondence Address: STEVENS DAVIS MILLER & MOSHER, LLP, 1615 L STREET, NW, SUITE 850, WASHINGTON, DC, 20036, US

(21) Appl. No.: 10/893,527

(22) Filed: Jul. 19, 2004

(51) Int. Cl. B32B 3/10

(52) U.S. Cl. 428/131; 428/422

(57) ABSTRACT

A multilayer laminate suitable for forming cladding such as siding, window and door surrounds, corners and other similar uses (hereinafter collectively “siding”) for covering dwellings or buildings. The multilayer laminate permits uses in hostile environments having temperatures above 100° F. and may be provided in dark, as well as light, colors. The laminate comprises at least a high impact layer, a weather layer and a heat resistant layer.

### 1. FIELD OF THE INVENTION

The need exists in residential and commercial building to provide protection from the elements, especially the heat and radiation of the sun, the effects of cold, impact, e.g., hail, and other weather factors experienced in all types of climate throughout the world. The present invention satisfies those needs by providing a composite material based on synthetic polymer technology. The composite material of the invention finds many uses as cladding for buildings, e.g., siding for dwellings, window and door surrounds, corners and other similar uses (hereinafter collectively “siding”).

### 2. BACKGROUND OF THE INVENTION

Materials to cover a dwelling have been known throughout history from the early use of skins draped over a frame to the use of wood planks and/or shingles; asbestos cement; asphaltic based composites; aluminum and, more recently, plastics based on polyvinyl chloride (PVC). The last material is not subject to the rot and/or insect infestation as are the wood based materials, nor heavy, or potentially hazardous like the asbestos cement and asphaltic based materials. Aluminum is subject to denting by hail and fading from the effects of the weather, especially the radiation of the sun. Polyvinyl chloride has been one of the better siding materials insofar as it does not rot like wood; is more prone to resist denting unlike aluminum; but also suffers from drawbacks like aluminum in that it fades under the effect of exposure to the elements, it has been available in only light colors, such as white, cream, yellows and pastels, it cannot be used where temperatures exceed 100° F., like the American southwestern states of Arizona, New Mexico or Nevada, or similar foreign environments, does not possess the strength necessary to be a satisfactory material and cannot be made into darker colors. Thus, despite the proliferation of polyvinyl chloride siding over the past decades, there is still a need for a siding material that overcomes the deficiencies of the prior art.

### 3. SUMMARY OF THE INVENTION

In order to provide a material suitable as siding in various climates of the world, the inventors have formulated a composite material that can be formed into various siding configurations, e.g., siding having an interlocking configuration and a nailing hem, various shapes of which are known in the art; window and door surrounds of complex, multiplanar shape with arcuate corners; corner moldings and other similar shapes for covering a dwelling or other building.

In one embodiment, the invention can provide siding which can be tinted to deep colors such as Wineberry, Forest Green, Black, Tuxedo Gray, Midnight Blue and Bordeau (as well as the conventional colors of the heretofore known siding).

The invention provides a composite synthetic polymeric formulation which in one embodiment provides at least a three layer composite in which at least two of the layers (preferably at least three layers) are coextruded or, alternatively, at least one of the layers is optionally laminated to the coextruded intermediate.

In a particularly preferred embodiment, a composite is shaped into a siding which provides heat resistance, high impact and weather resistance properties.

### 4. BRIEF DESCRIPTION OF THE DRAWINGS

FIG. 1 is a schematic view of the different layers of the composite in one embodiment of the invention.

FIG. 2 is a schematic view of a door surround according to one embodiment of the invention.

FIG. 3 is a schematic representation of an apparatus for making a composite material according to one embodiment of the invention.

### 5. DETAILED DESCRIPTION OF THE PREFERRED EMBODIMENTS

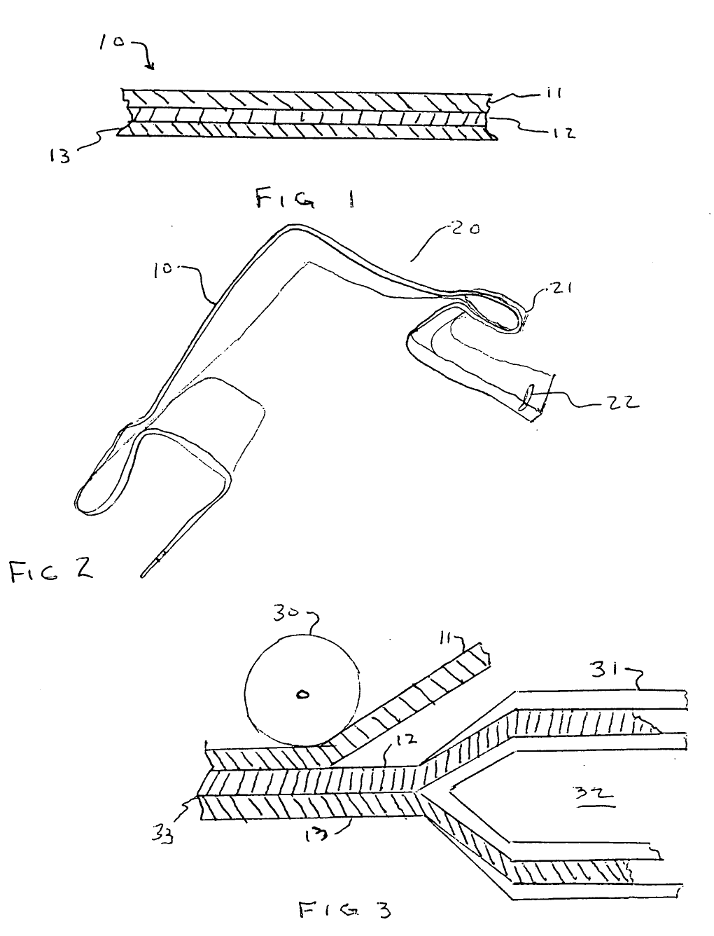

The composite material of the invention as shown in one embodiment of FIG. 1 comprises at least three layers 11, 12 and 13, preferably of which at least two are coextruded and at least one of which is laminated to the coextrudate. In other embodiments of the invention, at least three of the layers are coextruded.

In the one embodiment of FIG. 1, layer 11 is a material exhibiting heat resistance properties such as a synthetic polymeric material. Especially preferred are thermoplastic polymers such as chlorinated polyvinyl chloride (CPVC). Such polymeric material is suitable mixed with a filler/pigment such as carbon black, inert fillers such as silica, diatomaceous earth and similar filler materials but, preferably, also includes an organotin component. Other components may include one or more of polyethylene wax, paraffin wax, calcium stearate and antioxidants. An alternative polymeric material is an acrylonitrile-butadiene-styrene (ABS)-based material also containing a filler/pigment, such as carbon black, etc.

Layer 12 is a high-impact layer, preferably also comprised of a synthetic polymeric material, especially a thermoplastic such as polyvinyl chloride (PVC), optionally including a filler or pigment. Among the preferred filler or pigment is titanium dioxide. Also included within the layer 12 are one or more of polyethylene wax, paraffin wax, calcium stearate and a tin stabilizer.

Layer 13, or the weather layer exposed to the environment, is a polymeric material preferably comprising a blend of different polymeric materials. We have found that a polyvinyldifluoride (PVDF) and acrylic film or an acrylic/acrylic styrene acrylionitrile (ASA) resin are preferred materials. This weather layer may comprise one or more of pigments and dyes to impart the dark colors mentioned hereinabove of the light colors known to the prior art siding.

As shown in one manufacturing process of FIG. 3, the layers 12 and 13 can be co-extruded from die 31 of an extruder 32 which can be optionally temperature controlled, e.g., heated. The co-extruded layers 12, 13 will adhere at their interface 33. In the embodiment illustrated in FIG. 3, layer 11 can be laminated to the co-extrudate 12, 13 under the effects of pressure of roller 30, preferably while the co-extrudate 12, 13 is still hot from the extrusion process. However, it is to be understood that the invention is not so limited to lamination while the coextrudate 12, 13 is still hot from the extrusion process. A solvent, adhesive, or reheat of either the co-extrudate 12, 13 and/or layer 11 can be used to facilitate bonding of layer 11 to the co-extrudate 12, 13. Additionally, in the embodiment of FIG. 3, the use of solvent or adhesive, or heating of layer 11 can take place upstream of the application of pressure by roller 30 to facilitate the lamination to co-extrudate 12, 13.

Although not shown, layers 11, 12, 13 can all be co-extruded in a manner similar to FIG. 3, but using an extrusion die configured to co-extrude at least three layers. Such extrusion dies are known in the art. Those skilled in the art will appreciate that the siding of the invention can contain additional components other than those expressly described, including anti-blocking agents, plasticizers, cross-linking agents, and such other components to facilitate processing and/or resistance to the elements.

After formation of the composite, the composite can be shaped by rollers, or a pultrusion die or combination thereof, into a complex multiplanar shape 20 connected by rounded corners 21 as schematically illustrated in FIG. 2.

Alternatively, when the composite has at least three co-extruded layers, the siding can be tri-extruded into a semi-finished or finished form directly from the extrusion die. In some embodiments of the invention, such as where a single or double nailing hem is desired only a portion of the extrudate needs to be reshaped after extrusion, e.g., by folding over the hem portion to form the double nailing hem. Apertures 22 may be formed in the siding by punching holes through the hem portion during manufacture to facilitate installation of the siding.

The invention will be further understood by reference to the following examples.

### EXAMPLE 1A

HEAT RESISTANT LAYER 11 MAKEUP

| COMPOSITION | PERCENTAGE (%) |
|---|---|
| Chlorinated polyvinyl chloride (CPVC) | >78 |
| Nonhazardous ingredients* | <18 |
| Organontin | >2.0 |
| Carbon Black | <2.0 |

*Polyethylene wax, paraffin wax, calcium stearate, antioxidant

### EXAMPLE 1B

ALTERNATE POLYMER

| COMPOSITION FOR LAYER 13 | PERCENTAGE (%) |
|---|---|
| Acrylonitrile-butadiene-styrene | 30-100 |
| Carbon Black | <2 |

### EXAMPLE 2

HIGH IMPACT LAYER 12

| COMPOSITION | PERCENTAGE (%) |
|---|---|
| Polyvinyl chloride resin | 85 |
| Titanium Dioxide | 1 or less |
| Processing ingredients** | 14 |

**Polyethylene wax, paraffin wax, calcium stearate, tin stabilizer

### EXAMPLE 3

WEATHER RESISTANCE LAYER 11

| COMPOSITION | PERCENTAGE (%) |
|---|---|
| PVDF/Acrylic Film or Acrylic/ASA Resin*** | 100 |

***Dyes and/or pigments may be optionally added to achieve light colored or dark colored exterior or weather surface.

It is to be understood that the invention is not limited to the specific embodiments or examples disclosed herein since those skilled in the art will be able to envision other embodiments upon reading this disclosure without departing from the spirit and scope of the invention as defined in the appended claims.

We claim:

1. A laminate comprised of the following laminae:
a. a chlorinated polyvinyl chloride (CPVC) or an acylonitrile-butadiene-styrene (ABS) containing polymeric composition;
b. a polyvinyl chloride resin composition; and
c. a polyvinyl difloride (PVDF)/acrylic film or acrylic-styrene-acrylonite (ASA) resin containing composition.

2. The laminate of claim 1, wherein each of the CPVC and ABS contains carbon black.

3. The laminate of claim 1, wherein the CPVC contains an organotin compound.

4. The laminate of claim 1, wherein each of the CPVC and PVC contains at least one component selected from the group consisting of polyethylene wax, paraffin wax and calcium stearate.

5. The laminate of claim 1, wherein the CPVC contains an antioxidant.

6. The laminate of claim 1, wherein the PVC contains a tin stabilizer.

7. A cladding formed by shaping the laminate of claim 1.

8. The cladding of claim 7, comprising a siding having a nailing hem, said nailing hem defining apertures.

9. The cladding of claim 8, wherein said nailing hem has a thickness of at least twice the thickness of the laminate.

10. The cladding of claim 7, in the form of a window surround.

11. The cladding of claim 7, in the form of a door surround.

12. The cladding of claim 7, in the form of a corner.
